(19) United States
(12) Patent Application Publication
(10) Pub. No.: US 2014/0057694 A1
(43) Pub. Date: Feb. 27, 2014

(54) WAGERING GAME WITH SPECIAL FUNCTION COMMUNICATING MULTIPLE MEANINGS

(71) Applicant: MULTIMEDIA GAMES, INC., AUSTIN, TX (US)

(72) Inventors: Brian Watkins, Austin, TX (US); Michael Conway, Austin, TX (US)

(73) Assignee: MULTIMEDIA GAMES, INC., AUSTIN, TX (US)

(21) Appl. No.: 13/625,089

(22) Filed: Sep. 24, 2012

Related U.S. Application Data
(63) Continuation-in-part of application No. 13/591,738, filed on Aug. 22, 2012.

(51) Int. Cl. A63F 13/00

(52) U.S. Cl. 463/20

(57) ABSTRACT

A gaming system, apparatus, and method are disclosed with one or more special function zones which foreshadow or hint at game results in a manner designed to create a lucky or positive impression with the player. A preferred version provides a slot machine game with a special function zone behind and around the reels, which animates in certain circumstances to predict the outcome of a reel spin. The animation may have different meanings depending on the context within the game.

### CROSS-REFERENCE TO RELATED APPLICATION

This application is a continuation-in-part of U.S. patent application Ser. No. 13/591,738 filed Aug. 22, 2012, and entitled “Wagering Game With Player Activated Special Function Which Simulates Predicting The Game Outcome.” The Applicants claim the benefit of this earlier nonprovisional patent application under 35 U.S.C. §120. The entire content of this nonprovisional application is incorporated herein by this reference.

### FIELD OF THE INVENTION

This invention relates to wagering games, gaming machines, networked gaming systems and associated methods. More particularly, the invention relates to wagering games, gaming devices, networked gaming systems, and associated methods including player interactive features that may be seen to predict a game outcome.

### BACKGROUND

A large number of different gaming machines have been developed to provide various formats and graphic presentations for conducting games and presenting game results. Many past slot machine games have presented player interactive features designed to provide “perceived skill,” that is to provide the impression that the player interaction with game elements has some skill-based outcome on the game. Typically, of course, true skill based games are not allowed under the regulatory schemes for games of chance (with exceptions such as blackjack and poker games), and the effect of the player's skill is only perceived, while the outcome is predetermined and may be reverse-mapped to fit choices made by the player.

However, seasoned players have seen a few generations of perceived skill type games and many have tired of having to make inputs that do not actually affect the game outcome or increase the game's level of interest for the seasoned player. There continues to be a need to generate more player interest and excitement by providing new aspects to games.

### SUMMARY OF THE INVENTION

The present invention includes wagering games, gaming machines, networked gaming systems and methods with one or more special function zones which allow player interaction in a manner that provides a “perceived luck” rather than a perceived skill. A preferred version provides a slot machine game with a special function zone that animates to communicate information to the player. The special function animation has a different meaning depending on the context in which it is employed in the game. The game is constructed such that the players can perceive the different meanings and come to associate them as lucky. In one version, the special function animation occurs while the reels are spinning for the base game, occurring as a second animation preferably in a special function zone surrounding and beside the reels. This second animation foreshadows a reel stop which will hit a designated high-value outcome, which in the preferred game can be an outcome in which certain symbols are designated wild, or an outcome containing one or more stacked wilds (which match a player selected good luck charm) and will pay a total prize above some threshold. That is, in the context of a base game the second animation has a first meaning that it hints at or predicts a high-value award. Then, in a free spin bonus round, the same second animation has a second meaning that bonus symbols have a special function, such as being wild.

In some versions, there may be an additional random number drawn or other decision made to determine whether to show the second animation. For example, the second animation may only occur a certain percentage of the time when the other conditions are satisfied.

Another version of the invention is a computer program stored on a non-transitory readable medium. The software version is, of course, typically designed to be executed by a gaming machine or networked gaming system. The software includes multiple portions of computer executable code referred to as program code. Gaming results are provided in response to a wager and displayed by display program code that generates simulated slot reels each including one or more symbol locations. The program also has game controller program code for determining game play results involving spins or other randomization of an array of symbols, and providing the selectable special function zone and its animations.

Another version of the invention is a gaming system that includes one or more gaming servers, and a group of electronic gaming machines connected to the servers by a network. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. For example, different animation themes may be applied that display the application of the special function zone field in different ways.

These and other advantages and features of the invention will be apparent from the following description of the preferred embodiments, considered along with the accompanying drawings.

### BRIEF DESCRIPTION OF THE DRAWINGS

FIG. 1A is a screen diagram of a primary game display including an example reel game with a special function zone.

FIG. 1B is a screen diagram of the same game display showing a special function animation in progress in the special function zone.

FIG. 2A is a flowchart showing an example of the game play process at a gaming machine that includes the special function zone feature according to an example embodiment.

FIG. 2B is a flowchart showing a game play process according to another embodiment of the invention.

FIG. 3A is a front perspective view of a gaming machine which may be used in a gaming system embodying the principles of the present invention.

FIG. 3B is a block diagram showing various electronic components of the gaming machine shown in FIG. 3A together with additional gaming system components.

FIG. 4A is a system block diagram of a gaming system according to one embodiment of the present invention.

FIG. 4B is a system block diagram of a gaming system according to another embodiment of the invention.

### DETAILED DESCRIPTION OF PREFERRED EMBODIMENTS

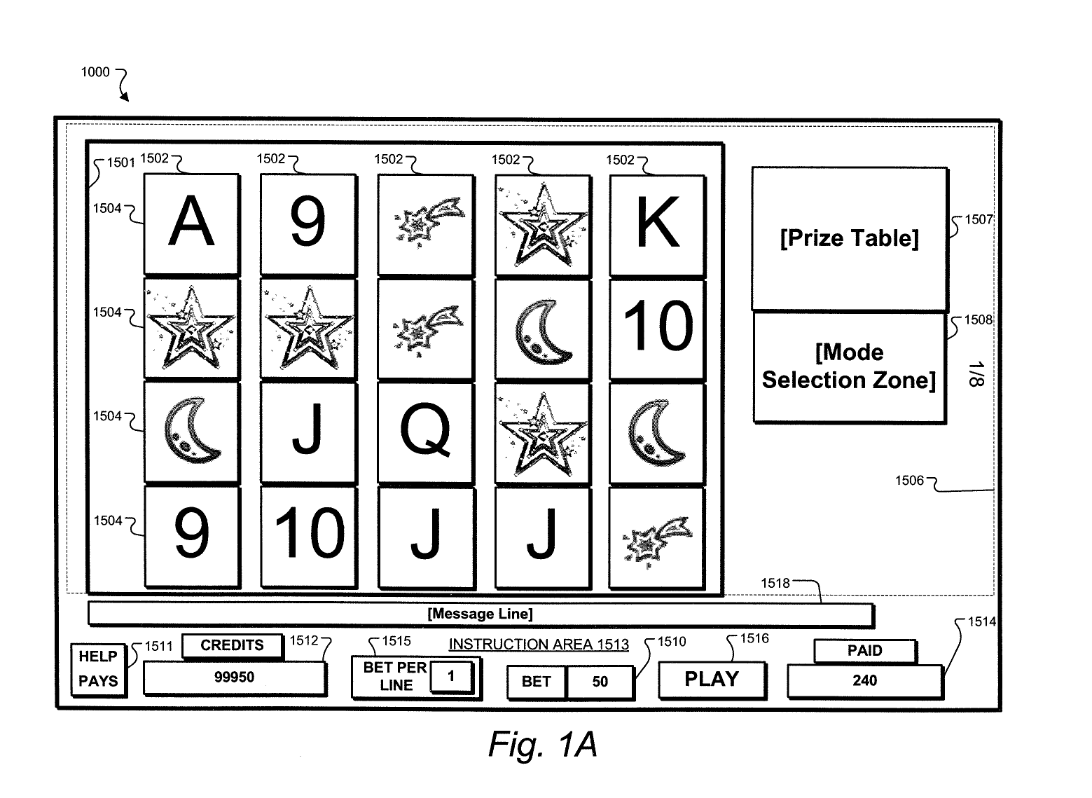

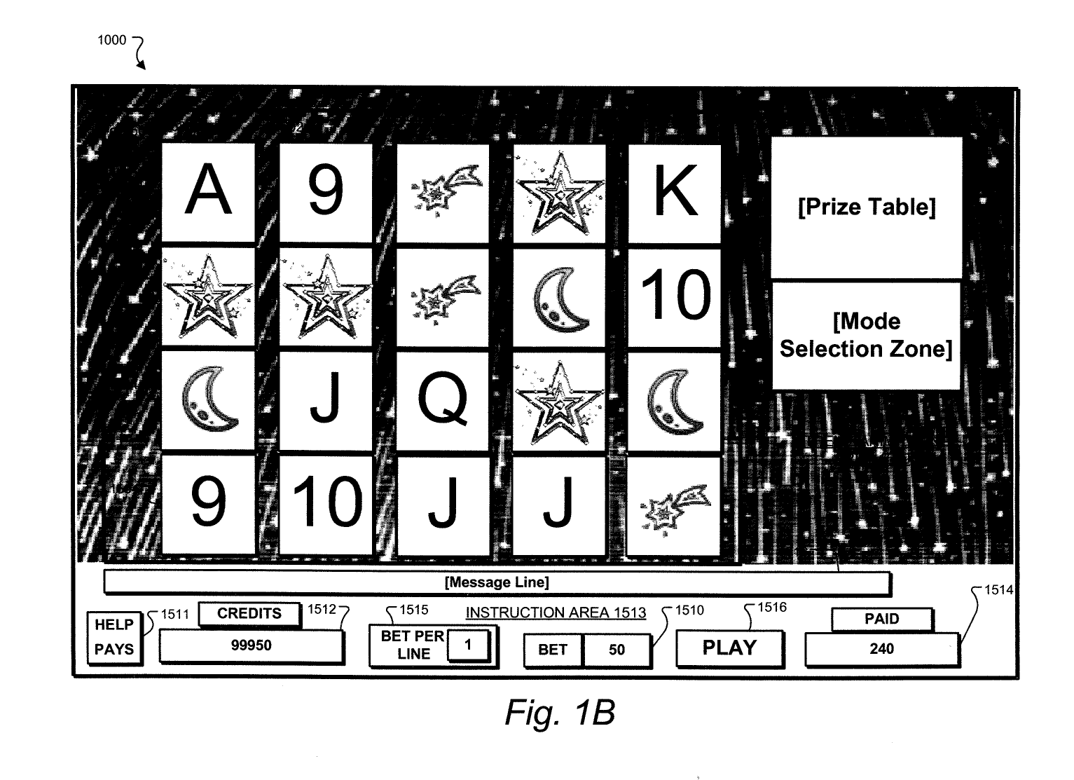

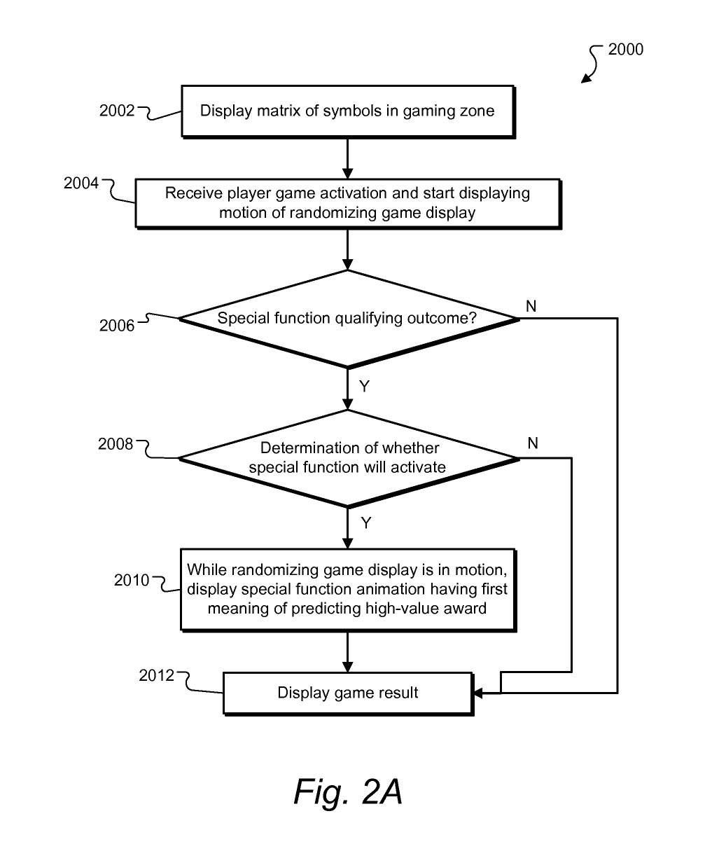

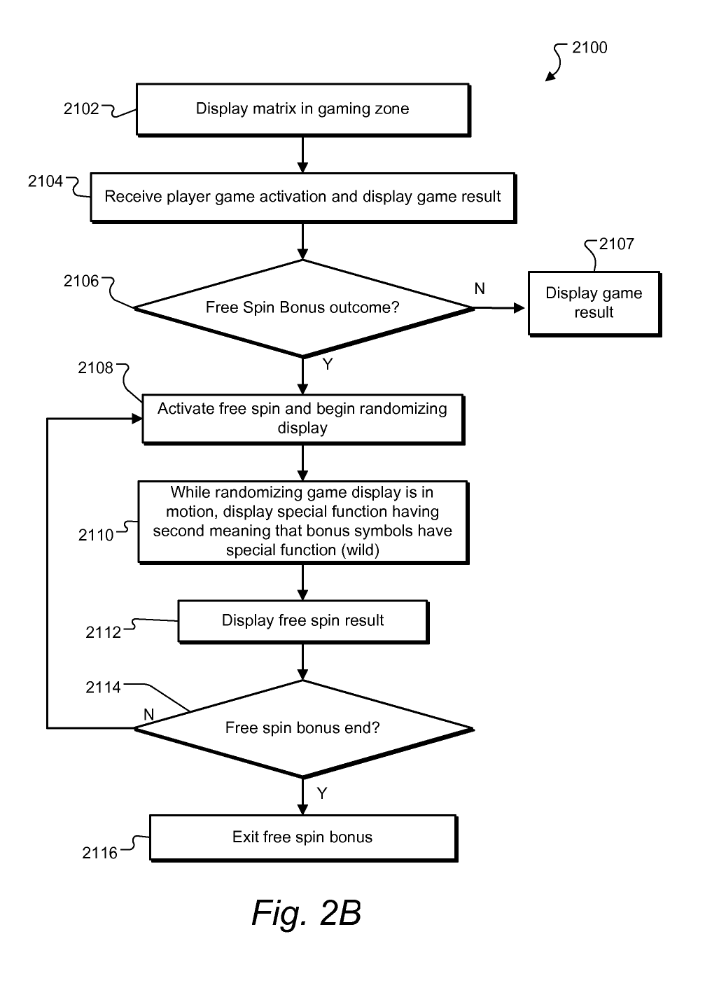

FIG. 1A is a screen diagram of primary game display or game screen 1000 including an example reel game with a special function zone. FIG. 1B is a screen diagram of the same game display showing a special function animation in progress in the special function zone. The use, function, and meaning of the special function animation will be further described with respect to the flowcharts shown in FIGS. 2A and 2B.

Referring to FIGS. 1A-B, depicted is an example game screen diagram of game screen 1000. In this example embodiment, game screen 1000 has a first gaming zone, which in this embodiment is a matrix of symbol locations 1501, in which is displayed the primary conduct of the base game. The matrix of symbol locations 1501 consists of five simulated reels 1502, and each reel has four positions or symbol locations 1504, which are animated with a first animation to show a game being conducted to a result. Behind and surrounding the symbol locations 1504 is the special function zone 1506. Importantly, the special function zone also performs a second animation, further described below, which predicts a designated high-value winning outcome before it is shown on the reels. In a preferred game, under the special function zone 1506 there is a mode selection zone 1508, which in some embodiments provides the player ability to make selections regarding the game mode and function. As can be seen in FIG. 1B, the special function zone 1506 is animated under certain conditions to show a second animation, preferably while the matrix 1501 is animated to show the randomization of symbols meaning a game is in progress. The animation in this embodiment is a shooting star animation consistent with the night sky theme of the depicted symbol set. While in this embodiment the special function zone 1506 extends behind the animated symbol locations 1504 to both horizontal edges of the game screen 1000, and behind the prize table 1507 and mode selection zone 1508, in other versions the special function zone 1506 may have a different size and shape than the one depicted. Preferably, the special function zone 1506 always extends behind the symbol locations, such that the second animation depicted therein is apparent to a player whose attention is drawn to the randomizing symbol locations 1504. However, some versions may place the special function zone 1506 entirely outside the matrix 1501. Other versions may provide a special function zone 1506 that shows a small animation within the matrix 1501, but not as a background to the entire matrix as the depicted zone 1506 provides. The second animation may also be shown to interact with the symbol animations in symbol locations 1504.

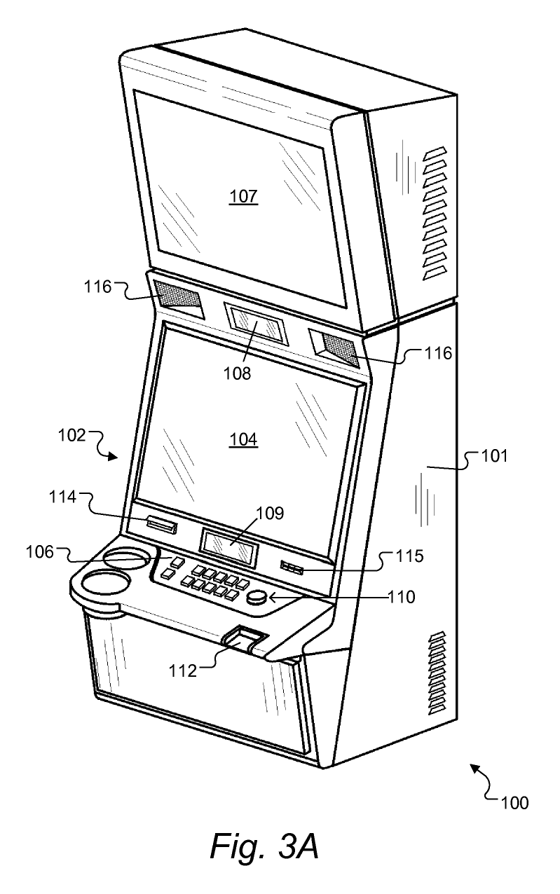

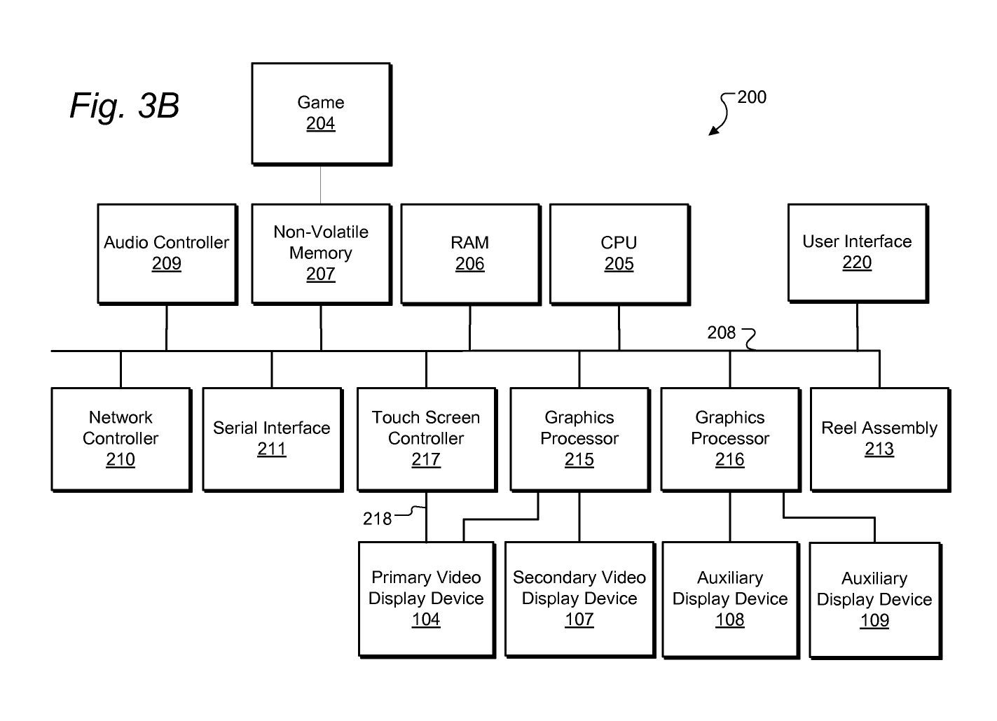

Along the bottom of the diagram in FIG. 1A are found various game information and interaction buttons such as the current wager display 1510, available credits display 1512, the current payout display 1514, and the bet per line display 1515. The touchscreen play button 1516 may be used instead of the manual button shown on the example gaming cabinet in FIG. 3A. The Help/Pays button 1511 accesses the help screen and paytable information for the game. Along the bottom of the matrix 1501, there is a message line 1518 for showing current messages to the player from the game or gaming network. Between the message line 1518 and the lower display items is an instruction area 1513 which is updated to display various instructions or feature explanations regarding the game.

FIG. 2A is a flowchart showing an example of the game play process at a gaming machine that includes the special function zone feature according to an example embodiment. This flowchart 2000 includes the special function zone functionality for the preferred embodiment. The process starts at step 2002 where the game displays an arrangement of symbols in the matrix 1501 which are updated to show play of the game. This display is achieved by controlling a touch sensitive gaming display with one or more electronic processors under the control of suitable program code, such as is done with the preferred gaming machine embodiment shown in FIG. 3A. The gaming display shown at this step further includes the special function zone, but it may have a standard animation associated with the base game, or static graphics. The special function zone 1506 may, at this point, be identified graphically somehow with a visual indication of its edges, or may be entirely blended with the background graphics of the base game.

Next, at step 2004, the process receives a player game activation and, in response, begins an animated display in the first gaming zone showing motion in the symbol locations indicating a game is in progress. In the preferred game this animation shows the simulated reels 1502 spinning Other known games including randomizing of game elements, or other non-random animations may also be used. The game display at this step occurs over a period of time sufficient so that the player may perceive or notice whether an animation occurs in the special function zone, or may observe that a different animation than usual is shown in the special function zone in this period. The preferred process at this step also obtains the randomized game outcome, preferably from a gaming server as described below. Receiving this outcome provides no perceptible delay to the process, and the outcome is therefore available when it is needed for decisions in the process steps below.

At step 2006, the process checks if the game outcome of the current game play being shown in the first gaming zone, (which is already determined by the gaming machine or game server at this point) is going to be a designated high-value win outcome. If so, it is possible that the special function zone may display the second animation to predict the reels stopping to display a designated high-value outcome. In some versions, this condition is all that is needed and the process goes straight from step 2006 to step 2010 and displays the second animation while the reels are spinning. Other versions only display the second animation a certain percentage of the time that the qualifying designated high-value outcome is achieved. Such versions include step 2008 which determines whether the special function zone will activate and display the second animation. This step may be made in any suitable way that decides whether each particular designated high-value outcome will be predicted by the second animation. The decision may be random or pseudo random, and may be made to enforce a percentage probability that the animation will occur for any particular designated high-value win. The decision may be based on player history or the amount of time since a designated high-value award was won. The decision may be made based on a plurality of circumstances in a way to re-enforce the perception that the special function zone is lucky in some manner. For example, if a designated high-value award has not been won in a relatively large number of plays, step 2008 may decide to activate the special function zone in order to associate the second animation with the already-determined designated high-value award in the player's mind.

Concerning the second animation in the special function zone, referred to as a special animation in step 2010 because it preferably differs from other animations that may be shown, the second animation preferably starts soon after the reels start spinning. This allows the animation to be conducted for the majority of the time the game animation is conducted (reels spin), typically a few seconds. This increases the chance that the player will notice the second animation and mentally identify it as predicting the designated high-value outcome that shows up on the reels. An example freeze-frame of an example second animation may be seen in FIG. 1B, where the special function zone 1506, shows a shooting stars animation. Preferably a sound accompanies the animation, also designed in a manner to draw the player's attention to the second animation in a way that communicates something lucky or special is happening while the reels are spinning. In the depicted version, the shooting stars animation means the game outcome includes all bonus symbols being made wild, which provides for a high-value prize by forming many winning patterns. Preferably the second animation continues through the prize presentation phase of the main game presentation. Other versions may stop the second animation when the reels stop.

Further, the content of the second animation may vary to communicate to the player that different beneficial outcomes are about to happen. In a preferred game, the second animation depicts a moon-rise in the special function zone to predict or communicate that an outcome with a stacked wild symbol and high-value prize will occur, but depicts a shooting stars animation to predict or communicate that all bonus symbols in the matrix 1501 are going to be wild in this particular game result. Preferably, the second animation turning symbols wild appears to the player as a “mystery” event, meaning there is no indication as to what caused it to happen according to the game rules. In the preferred game, the shooting stars are therefore a mystery animation when they occur in the base game.

Next, at step 2012 in FIG. 2A, after displaying the second animation sequence, the process stops the animated display of reels spinning in the first gaming zone to show a game result in the symbol locations. The presentation of the game result continues with identifying the paylines and awards produced by the designated high-value outcome. This step includes paying an award for game results that are winning game outcomes. As shown in the process flowchart of FIG. 2A, if the conditions for activating the second animation in the special function zone are not met at any of steps 2006 or 2008, the process skips to normally displaying the game result at step 2012.

FIG. 2B is a flowchart showing a game play process according to one or more other embodiments of the invention. The depicted process 2100 preferably occurs in the same base game as process 2000 of FIG. 2A, but may occur as a stand-alone feature in some versions. Process 2100 includes the use of a second animation in the special function zone as part of a free spin bonus round. Some embodiments may provide game outcomes in which the base game uses a second animation, and a free spin bonus round also uses a second animation in the same game result. Other embodiments may never have such a scenario. The depicted process at step 2102 displays the gaming matrix in the first gaming zone and displays the special function area in the manner described for step 2002 of process 2000.

Next, at step 2104, the process receives a player game activation and, in response, begins to display a game result, which may include other features and animations, but particularly may include a free spin bonus outcome triggered by a designated pattern. In one embodiment, the free spin trigger pattern is three or more bonus symbols scattered on any of the five reels. The process next at step 2106 determines if a free spin bonus trigger occurred, and if not the process displays the game result with any other features it contains at step 2107. If a free spin result is found at step 2106, the process goes to step 2108 where the free spin round is conducted, including special function zone animations as described below.

The free spin bonus round preferably includes multiple free spins that are each begun with a free spin activation at step 2108. The activation is preferably automatic but may be a player input. This begins a first animation in the matrix 1501, or other gaming zone implementation. While the first animation is occurring, the second animation is displayed in the special function zone 1506. In this context, the second animation has the meaning that the spin result will be adjusted from the normal function to make all bonus symbols include a special function. Preferably, this function is the bonus symbols are made wild, but other special functions may be used. What is important is that the second animation, employed in the context of a bonus round, communicates a designated meaning to the player before the game result is shown by stopping the animated reel spinning or other gaming zone randomization. In the preferred embodiment, the shooting stars animation is shown to designate that bonus symbols are wild. The second animation is conducted with timing similar to that described above, to communicate to the player that something special is going to occur in the free spin result. Next, at step 2112, the free spin result is shown, and includes the special function as hinted or foreshadowed by the second animation. If more free spins are provided in the bonus round, the process at step 2114 returns to step 2108 for further free spin activations. If not, the process exits the free spin bonus at step 2116.

FIG. 3A shows a gaming machine 100 that may be used to implement a special function zone game according to the present invention. The block diagram of FIG. 3B shows further details of gaming machine 100. Referring to FIG. 3A, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 3A also includes a number of mechanical control buttons 110 mounted on ledge 106. These control buttons 110 may allow a player to select a bet level, select paylines, select a type of game or game feature, and actually start a play in a primary game. Further, primary video display device 104 in gaming machine 100 provides a convenient display device for implementing touchscreen controls.

It will be appreciated that gaming machines may also include a number of other player interface devices in addition to devices that are considered player controls for use in playing a particular game. The ledge may also include a hardware special object including a button, touch sensor, or switches, joysticks, or other mechanical input devices, and/or virtual buttons and other controls implemented on a suitable touchscreen video display. Gaming machine 100 also includes a currency/voucher acceptor having an input ramp 112, a player card reader having a player card input 114, and a voucher/receipt printer having a voucher/receipt output 115. Audio speakers 116 generate an audio output to enhance the user's playing experience. Numerous other types of devices may be included in gaming machines that may be used according to the present invention.

FIG. 3B shows a logical and hardware block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on bus 208 and is connected to drive primary video display device 104 and secondary video display device 107 (both mounted on cabinet 101 as shown in FIG. 3A). A second graphics processor 216 is also connected on bus 208 in this example to drive the auxiliary display devices 108 and 109 also shown in FIG. 3A. As shown in FIG. 3B, gaming machine 100 also includes a touch screen controller 217 connected to system bus 208. Touch screen controller 217 is also connected via signal path 218 to receive signals from a touchscreen element associated with primary video display device 104. It will be appreciated that the touchscreen element itself typically comprises a thin film that is secured over the display surface of primary video display device 104. The touchscreen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 3B are elements commonly associated with a personal computer. These elements are preferably mounted on a standard personal computer chassis and housed in a standard personal computer housing which is itself mounted in cabinet 101 shown in FIG. 3A. Alternatively, the various electronic components may be mounted on one or more circuit boards housed within cabinet 101 without a separate enclosure such as those found in personal computers. Those familiar with data processing systems and the various data processing elements shown in FIG. 3B will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 3B as being connected directly on system bus 208 may in fact communicate with the other system components through a suitable expansion bus. Audio controller 209, for example, may be connected to the system via a PCI bus. System bus 208 is shown in FIG. 3B merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, it will be appreciated that CPU 205 may control all of the display devices directly without any intermediate graphics processor. In some embodiments, the special function zone may be displayed on secondary video display 107 rather than beside the matrix of symbol locations or other type of primary gaming zone on the primary display. The invention is not limited to any particular arrangement of processing devices for controlling the video display device included with gaming machine 100. Also, a gaming machine implementing the present invention is not limited to any particular number of video display devices or other types of display devices.

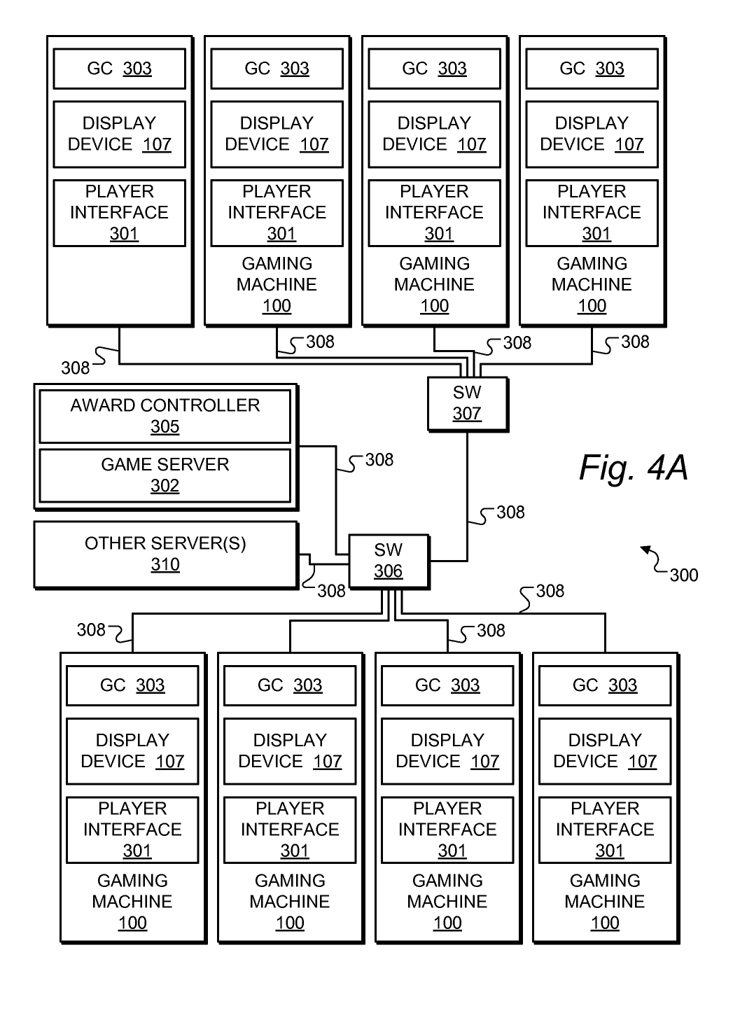

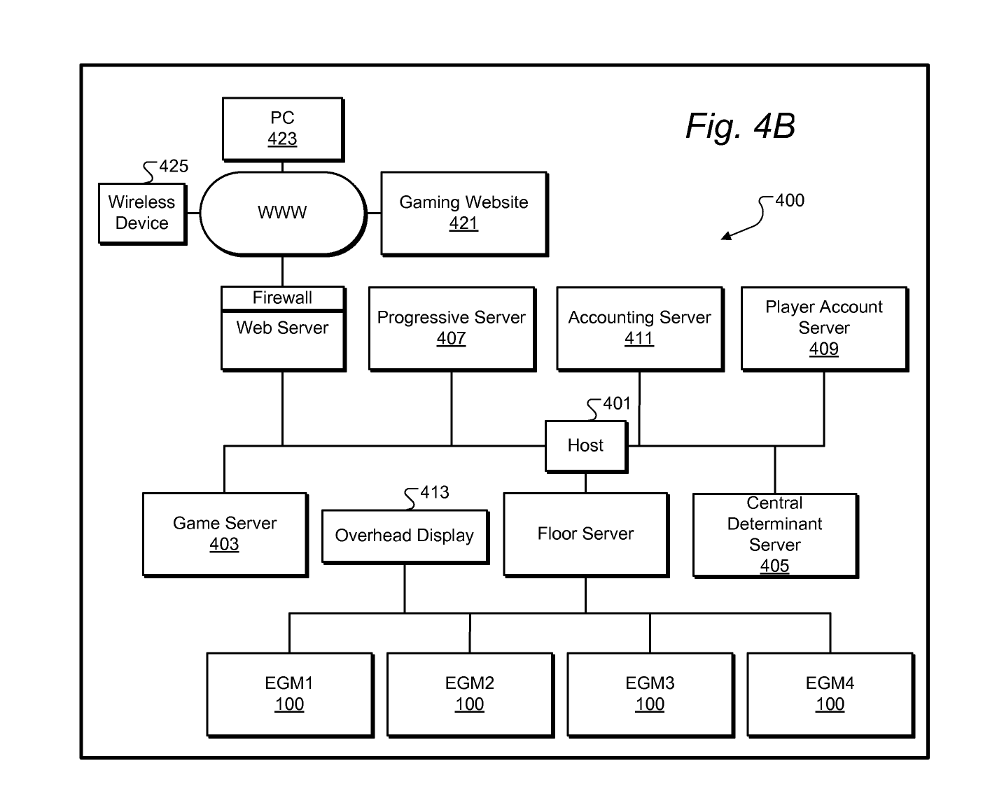

In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine. As will be discussed further below, CPU 205 either alone or in combination with graphics processor 215 may implement a presentation controller for performing functions associated with a primary game that may be available through the gaming machine, and may also implement a game client for directing one or more display devices at the gaming machine to display portions of a special function zone game according to the present invention. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs, while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included. In particular, network controller 210 provides an interface to a game controller which controls certain aspects of the special function zone game as will be discussed below in connection with FIG. 4A.

It should be noted that the invention is not limited to gaming machines employing the personal computer-type arrangement of processing devices and interfaces shown in example gaming machine 100. Other gaming machines through which a special function zone game is implemented may include one or more special purpose processing devices to perform the various processing steps for implementing the present invention. Unlike general purpose processing devices such as CPU 205, these special purpose processing devices may not employ operational program code to direct the various processing steps.

It should also be noted that the invention is not limited to gaming machines including only video display devices for conveying results. It is possible to implement a special function zone game within the scope of the present invention using an electro mechanical arrangement or even a purely mechanical arrangement for displaying the symbols or first and second animations as needed to complete the special function zone game as described herein. However, the most preferred forms of the invention utilize one or more video display devices for displaying the spinning reels and the selectable modifier elements. For example, a gaming machine suitable for providing a special function zone game may include a mechanical reel-type display rather than a video-type display device for displaying results in a primary game, and include a video display device for presenting the special function zone or object separately.

Still referring to the hardware and logical block diagram 200 showing an example design for a gaming machine 100, the depicted machine in operation is controlled generally by CPU 205 which stores operating programs and data in memory 207 with wagering game 204, user interface 220, network controller 210, audio/visual controllers, and reel assembly 213 (if mechanical reel configuration). CPU or game processor 205 may comprise a conventional microprocessor, such as an Intel Pentium microprocessor, mounted on a printed circuit board with supporting ports, drivers, memory, software, and firmware to communicate with and control gaming machine operations, such as through the execution of coding stored in memory 207 including one or more wagering games 204. Game processor 205 connects to user interface 220 such that a player may enter input information, and game processor 205 may respond according to its programming, such as to apply a wager and initiate execution of a game.

Game processor 205 also may connect through network controller 210 to a gaming network, such as example casino server network 400 shown in FIG. 4B. Referring now to FIG. 4B, the casino server network 400 may be implemented over one or more site locations and include host server 401, remote game play server 403 (which may be configured to provide game processor functionality including determining game outcomes and providing audio/visual instructions to a remote gaming device), central determinant server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards.

Referring now to FIG. 4A, a gaming system 300 according to another embodiment of the present invention is shown again in a network and system diagram format. System 300 includes a number of gaming machines, each comprising a gaming machine 100 in this example implementation. For purposes of describing system 300, each gaming machine 100 in FIG. 4A is shown as including a video display device 107 and a player interface 301 that may include buttons, switches, or other physical controls and/or touchscreen controls as discussed above in connection with FIG. 4A. System 300 further includes a game server 302 and a respective game client 303 (abbreviated “GC” in FIG. 4A) included with each respective gaming machine 100. In the form of the invention shown in FIG. 4A, these two components, game server 302 and the game client components 303, combine to implement a game control arrangement which will be described in detail below. System 300 also includes an award controller 305, which is shown in FIG. 4A as being associated with game server 302 to indicate that the two components may be implemented through a common data processing device/computer system. Gaming machines 100, game server 302, and award controller 305 are connected in a network communication arrangement including first and second network switches 306 and 307, connected together through various wired or wireless signal paths, all shown as communications links 308 in FIG. 4A.

Each gaming machine 100, and particularly player interface 301 associated with each gaming machine, allows a player to make any inputs that may be required to make the respective gaming machine eligible for a special function zone game, and make selections of any selectable objects displayed at the respective gaming machine in the course of the special function zone game. Player interface 301 also allows a player at the gaming machine to initiate plays in a primary game available through the gaming machine in some implementations. The respective video display device 107 associated with each respective gaming machine 100 is used according to the invention to generate the graphic displays to show the various elements of a special function zone game at the respective gaming machine.

The game control arrangement made up of game server 302 and the respective game client 303 at a given gaming machine functions to control the respective video display device 107 for that gaming machine to display a number of selectable modifier objects. Award controller 305 is responsible for awarding prizes for a player's participation in a special function zone game, and maintaining progressive prize information where the special function zone game offers one or more progressive prizes. The network arrangement made up of network switches 306 and 307, and the various communication links 308 shown in FIG. 4A is illustrated merely as an example of a suitable communications arrangement. It should be noted that the game control arrangement, or as it is referred to generally the “game controller,” may be implemented in some embodiments entirely on the gaming machine. This is especially true in jurisdictions that allow Class III gaming conducted with random number generators at each gaming machine. The present invention is not limited to any particular communications arrangement for facilitating communications between game server 302 and various gaming machines 100. Any wired or wireless communication arrangement employing any suitable communications protocols (such as TCP/IP for example) may be used in an apparatus according to the invention.

FIG. 4A shows other server(s) 310 included in the network. This illustrated “other server(s)” element 310 may include one or more data processing devices for performing various functions related to games conducted through system 300 and any other games that may be available to players through gaming machines 100. For example, apparatus 300 may be accounting servers providing support for cashless gaming or various forms of mixed cash/cashless gaming through the various gaming machines 100. In this example, an additional one of the other servers 310 will be included in apparatus 300 for supporting these types of wagering and payout systems. As another example, the various gaming machines 100 included in system 300 may allow players to participate in a game (primary game) other than the special function zone game described herein, and this other game may rely on a result identified at or in cooperation with a device that is remote from the gaming machines. In this example, another server 310 may be included in the system for identifying results for the primary game and communicating those results to the various gaming machines 100 as necessary. Generally, the other server(s) 310 shown in FIG. 4A are shown only to indicate that numerous other components may be included along with the elements that participate in providing special function zone games according to the present invention. Other server(s) 310 may provide record keeping, player tracking, accounting, result identifying services, or any other services that may be useful or necessary in a gaming system.

Referring to FIG. 4B, a block diagram of another example networked gaming system 400 associated with one or more gaming facilities is shown, including one or more networked gaming machines 100 in accordance with one or more embodiments. With reference to FIG. 4B, while a few servers have been shown separately, they may be combined or split into additional servers having additional capabilities.

As shown, networked gaming machines 100 (EGM1-EGM4) and one or more overhead displays 413 may be network connected and enable the content of one or more displays of gaming machines 100 to be mirrored or replayed on an overhead display. For example, the primary display content may be stored by the display controller or game processor 205 and transmitted through network controller 210 to the overhead display controller either substantially simultaneously or at a subsequent time according to either periodic programming executed by game processor 205 or a triggering event, such as a jackpot or large win, at a respective gaming machine 100. In the event that gaming machines 100 have cameras installed, the respective player's video images may be displayed on overhead display 413 along with the content of the player's gaming machine 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Blackberry cell phone, Apple iPhone, personal data assistant (PDA), iPad, etc.). To enter the website, a player may log in with a username (that may be associated with the player's account information stored on player account server 409 or be accessible by a casino operator to obtain player data and provide promotional offers), play various games on the website, make various personalizing selections and save the information, so that during a next gaming session at a casino establishment, the player's playing data and personalized information may be associated with the player's account and accessible at the player's selected gaming machine 100.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method for providing a wagering game including:
(a) controlling a touch sensitive gaming display with one or more electronic processors, the gaming display including a first gaming zone comprising a matrix of symbol locations which are updated to provide results of the game, the gaming display further comprising a second special function zone;
(b) receiving a player game activation and, in response, beginning an animated display in the first gaming zone showing motion in the symbol locations indicating a game play is in progress to produce a game outcome;
(c) determining whether the outcome, which is already determined, of the game play being shown in the first gaming zone is going to be a designated high-value win outcome, and if so, while conducting the animated display in the first gaming zone, displaying a second animation in the special function zone, the second animation having a first meaning for communication to a player;
(d) after displaying the second animation, stopping the animated display in the first gaming zone to show a game result in the symbol locations;
(e) paying an award if the game result is a winning game outcome;
(f) determining if the outcome is a free spin bonus outcome, and, in response, beginning a free spin bonus round including multiple free spin activations each providing a free spin randomization of the matrix of symbol locations and an award opportunity; and
(g) for each free spin, beginning a free spin animated display in the first gaming zone and, while conducting the free spin animated display, displaying the second animation in the special function zone, having a second meaning for communication to the player, and stopping the free spin to display a free spin result having a chance to win an award.

2. The method of claim 1, in which the second meaning is that all of a designated group of special symbols have a special function for the free spin result.

3. The method of claim 2, in which the special function is that the designated group of special symbols are all wild.

4. The method of claim 1, further comprising playing a sound along with displaying the second animation, the sound chosen to communicate the respective first or second meaning.

5. The method of claim 1, in which the matrix of symbol locations is a matrix of simulated slot machine reel symbol locations, and the animated display in the first gaming zone simulates spinning and stopping of simulated slot machine reels, and the second animation is begun after or as the simulated slot machine reels are shown to be spinning.

6. The method of claim 1, further including, in addition to meeting the condition that the outcome is a designated high-value win, making a further random determination as to whether the second animation will be shown in the special function zone.

7. A program product embodied in one or more tangible computer readable media, the program product including code executable by a gaming machine and at least one gaming server for:
(a) controlling a touch sensitive gaming display with one or more electronic processors, the gaming display including a first gaming zone comprising a matrix of symbol locations which are updated to provide results of a game, the gaming display further comprising a second special function zone;
(b) receiving a player game activation and, in response, beginning an animated display in the first gaming zone showing motion in the symbol locations indicating a game play is in progress to produce a game outcome;
(c) determining whether the outcome, which is already determined, of the game play being shown in the first gaming zone is going to be a designated high-value win outcome, and if so, while conducting the animated display in the first gaming zone, displaying a second animation in the special function zone, the second animation having a first meaning for communication to a player;
(d) after displaying the second animation, stopping the animated display in the first gaming zone to show a game result in the symbol locations;
(e) paying an award if the game result is a winning game outcome;
(f) determining if the outcome is a free spin bonus outcome, and, in response, beginning a free spin bonus round including multiple free spin activations each providing a free spin randomization of the matrix of symbol locations and an award opportunity; and
(g) for each free spin, beginning a free spin animated display in the first gaming zone and, while conducting the free spin animated display, displaying the second animation in the special function zone, having a second meaning for communication to the player, and stopping the free spin to display a free spin result having a chance to win an award.

8. The program product of claim 7, in which the second meaning is that all of a designated group of special symbols have a special function for the free spin result.

9. The program product of claim 8, in which the special function is that the designated group of special symbols are all wild.

10. The program product of claim 7, further for causing an audio device to play a sound along with displaying the second animation, the sound chosen to communicate the respective first or second meaning.

11. The program product of claim 7, in which the matrix of symbol locations is a matrix of simulated slot machine reel symbol locations, and the animated display in the first gaming zone simulates spinning and stopping of simulated slot machine reels, and the second animation is ended before the simulated slot machine reels are shown to stop spinning.

12. The program product of claim 7, further for, in addition to meeting the condition that the outcome is a designated high-value win, making a further random determination as to whether the second animation will be shown in the special function zone.
